(19) United States
(12) Patent Application Publication
(10) Pub. No.: US 2013/0179698 A1
(43) Pub. Date: Jul. 11, 2013

(54) SYSTEMS AND METHODS FOR OPTIONS RELATING TO POWER-ON OF A USER EQUIPMENT DEVICE

(71) Applicants: Thomas Steven Woods, Arlington Heights, IL (US); Michael R. Nichols, La Canada-Flintridge, CA (US)

(72) Inventors: Thomas Steven Woods, Arlington Heights, IL (US); Michael R. Nichols, La Canada-Flintridge, CA (US)

(73) Assignee: UNITED VIDEO PROPERTIES, INC., Santa Clara, CA (US)

(21) Appl. No.: 13/528,696

(22) Filed: Jun. 20, 2012

Related U.S. Application Data
(60) Provisional application No. 61/583,704, filed on Jan. 6, 2012.

(51) Int. Cl. G06F 1/00

(52) U.S. Cl. 713/300

(57) ABSTRACT

Systems and methods for setting up a power-on state of a user equipment device using a media guidance application are provided. A power-on state may specify media content related actions to be performed by the user equipment device when the user equipment device next powers on. In particular, in response to a user request to power off the user equipment device, the user may be presented with multiple power-on state options on a power-off screen. A user selection of a power-on state option may be received and a start-up routine of the user equipment device may be configured such that the user equipment device performs the media content related actions specified by the selected power-on state when it powers on.

### CROSS-REFERENCE TO RELATED APPLICATION

This application claims the benefit of U.S. Provisional Application No. 61/583,704, filed Jan. 6, 2012, the disclosure of which is hereby incorporated by reference herein in its entirety.

### BACKGROUND

As electronic devices get smarter, the user experience becomes more enjoyable. For example, electronic devices like televisions, Digital Video Recorders (DVRs), mobile phones, and many other personal electronic devices employ persistent user settings so that the user does not have to enter his or her preferences repeatedly. However, there is a need for the user experience to be improved further. Specifically, it is generally the case that each time electronic devices power on, they either display default media content or wait to receive user input to perform an action. In either case, the user must manually provide input to access media content desired at that particular time.

### SUMMARY OF THE INVENTION

The user experience can be further improved by pre-configuring electronic devices to perform predetermined actions related to media content upon powering on, or powering on in response to the occurrence of a predetermined media content related condition. In view of the foregoing, systems and methods for selecting power-on options applicable to a user equipment device are provided. Power-on state options may define the behavior of the user equipment device when the user equipment device powers on. In particular, a user may be presented with power-on state options in response to instructing the user equipment device to power off. The user may then select a power-on state option for application to the user equipment device. For example, a power-on module may store the selected power-on state option in a start-up routine of the user equipment device.

In some embodiments, the power-on state option selected by the user specifies media content that the user equipment device should display upon powering on. For example, the user may select a power-on state specifying that the user wishes to watch media content related to the latest sports news when the user equipment device powers on. The user equipment device may accordingly display sports news when it next powers on. When the user equipment device powers on, the media guidance application may search media content listings to locate identifiers of media content corresponding to sports and news. The media guidance application may then display media content corresponding to the located media content identifiers when the user equipment device powers on.

In some embodiments, the user equipment device powers on in response to receiving an instruction from the user to power on. For example, the user equipment device may receive an instruction from the user to power on via a hardware switch. In other embodiments, the power-on state option selected by the user specifies that the user equipment device should power on when specified media content is available for viewing from a media source accessible by the user equipment device. For example, before powering off, the user equipment device may store a future time to power on in a start-up routine. The future time may be based on a time when specified media content is available for viewing from a media source accessible by the user equipment device.

The user equipment device may display the specified media content once it powers on.

For example, the user may select a power-on state specifying that the user equipment device should power on whenever a reality show is available for viewing from content source 416 accessible by the user. Accordingly, the user equipment device may power on automatically at some future time when a reality show is being broadcast or when a reality show is available from an on-demand media content source. The future time when the reality show is available may be determined by searching media content listings for times when reality shows are broadcast and storing the determined future time in a start-up routine.

In some embodiments, the user is shown a power-off screen in response to a user request to power off the user equipment device. The power-off screen may include multiple power-on state options from which the user may select one power-on state option. In some embodiments, the user specifies default power-on states. In this case, in response to a user request to power off the user equipment device, the user may not be shown multiple power-on state options on a power-off screen. The user may set up a default power-on state option manually or the default power-on state option may be determined automatically based on the user's preferences stored in a user profile database.

In some embodiments, power-on state options are generated based on the user's profile information. For example, the media guidance application may generate the user's profile based on the user's interactions with the media guidance application. The user may additionally and/or alternatively provide user preferences to the media guidance application. Based on the media content preferences of the user, the media guidance application may generate power-on state options. For example, if the user typically watches the news on weeknights, the media guidance application may generate a power-on state specifying that the user equipment device should power on every weeknight and display news content.

In some embodiments, the power-on state option selected by the user is subject to parental control restrictions. For example, parental control restrictions limiting viewing of media content with excessive violence may be in place. Parental control restrictions may be stored in a parental control database of the user equipment device. Accordingly, based on the identity of the user, the selection of a power-on state specifying media content with graphic violence may be precluded. The user equipment device may identify the user via motion sensors, image recognition, or any suitable techniques. For example, if the user is a child, parental control restrictions may be enforced. If the user is an adult, parental control restrictions may not be enforced.

In some embodiments, the user is part of a social network. The user's social network friends may recommend power-on state options to the user. For example, the user's friend, Bob, may send a power-on state recommendation to the user specifying that the user's user equipment device should power on during a live broadcast of the Superbowl. In some embodiments, the user equipment device may periodically poll the user profiles of the user's social network friends to obtain information regarding their power-on state preferences in order to make power-on state suggestions to the user. In an embodiment, the social network is partially implemented locally on the user equipment device. In an embodiment, the social network is implemented on the Internet or other network. Social network websites like Facebook or Google+ may also be used.

In some embodiments, the user equipment device monitors its environment even when it has been powered off. For example, the user equipment device may monitor its vicinity for the presence of users using motion sensors, image sensors, or any other suitable detection technology. The user equipment device may be further capable of distinguishing between users who are members of the household in which the user equipment device is located and whose user profile is stored on the user equipment device and users who are not members of the household in which the user equipment device is located.

If a user, who is a member of the household in which the user equipment device is located, is detected in the vicinity of the user equipment device, the user equipment device may power on and display media content specified by the default power-on state corresponding to the detected user. If the detected user is not a member of the household in which the user equipment device is located, the user equipment device may either remain powered-off or may power-on and prompt the user to select media content to view.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIG. 5 shows an illustrative display screen showing a power-off screen with power-on state options, in accordance with an embodiment of the invention;

FIG. 6 shows an illustrative display screen showing a power-off screen with power-on state options, in accordance with an embodiment of the invention;

FIG. 7 shows an illustrative display screen showing a power-off screen with power-on state options based on the user's friends' recommendations, in accordance with an embodiment of the invention;

FIGS. 8A and 8B are illustrative display screens showing a power-off screen with power-on state options restricted by parental controls, in accordance with an embodiment of the invention;

FIG. 9 is a diagram of an illustrative system architecture for powering-on the user equipment device according to a selected power-on state, in accordance with another embodiment of the invention;

FIG. 10 shows an illustrative flow diagram for selecting a power-on state, in accordance with an embodiment of the invention;

FIG. 11 shows an illustrative flow diagram for applying a selected power-on state, in accordance with an embodiment of the invention;

FIG. 12 shows an illustrative flow diagram for selecting a power-on state based on the identity of the user in the vicinity of the user equipment device, in accordance with an embodiment of the invention;

FIG. 13 shows an illustrative flow diagram for generating power-on state options, in accordance with an embodiment of the invention; and

FIG. 14 illustrates an example of a format in which a power-on state may be stored, in accordance with an embodiment of the invention.

### DETAILED DESCRIPTION OF EMBODIMENTS

Systems and methods for setting up a power-on state of a user equipment device using a media guidance application are provided. A power-on state may specify media content related actions to be performed by the user equipment device when the user equipment device next powers on. In response to a user request to power off the user equipment device, the user may be presented with multiple power-on state options on a power-off screen. A user selection of a power-on state option may be received and a start-up routine of the user equipment device may be configured such that the user equipment device performs the media content related actions specified by the selected power-on state when it powers on. A media guidance application implemented on the user equipment device may perform the media content related actions.

The amount of content available to users in any given content delivery system can be substantial.

Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

The media guidance application may search media guidance data to determine future times when media content specified by the user in power-on states may be available. For example, in response to a user request to power off the user equipment device, the media guidance application may determine the next time that an episode of The Simpsons may be available on content source 416 accessible by the user. The media guidance data may include media content identifiers indicating the genre, category, type, or any other suitable classification of media content available via the media guidance data. For example, episodes of The Simpsons may be associated with media content identifiers such as comedy, animation, and/or family.

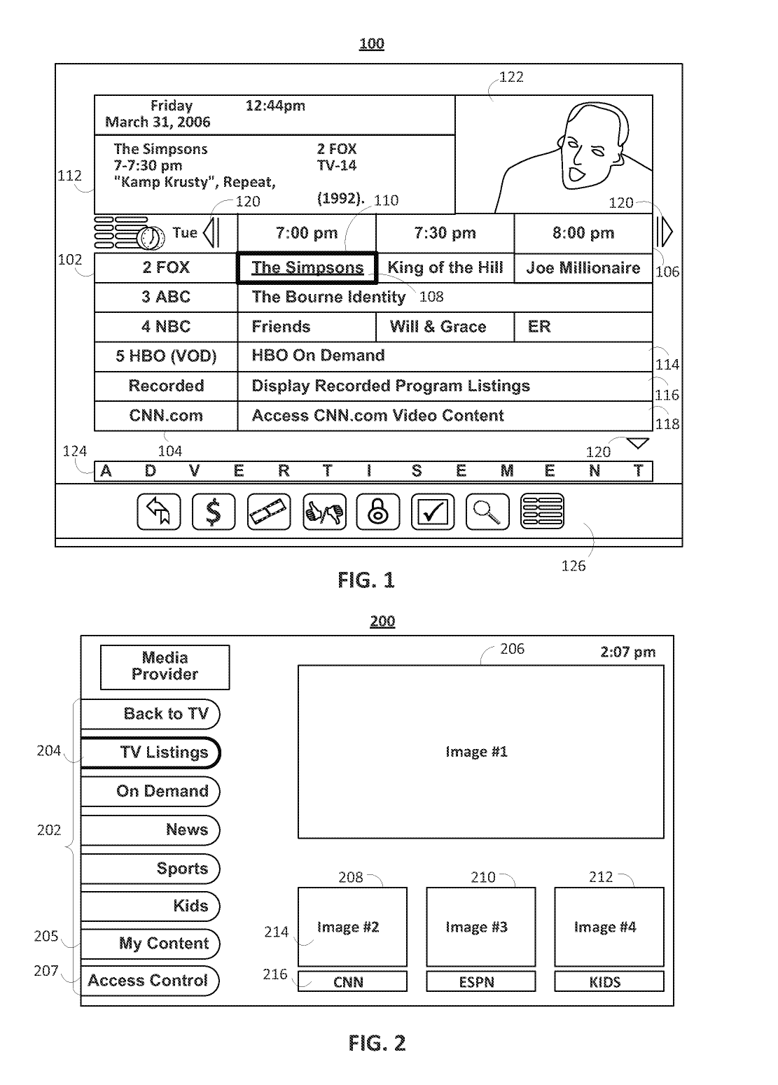

FIGS. 1-2, and 5-8B show illustrative display screens that may be used to provide media guidance data. The display screens shown in FIGS. 1-2 and 5-8B may be implemented on any suitable user equipment device or platform. While the displays of FIGS. 1-2 and 5-8B are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. User profile data may be stored in user profile database 940 as discussed below in connection with FIG. 9. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

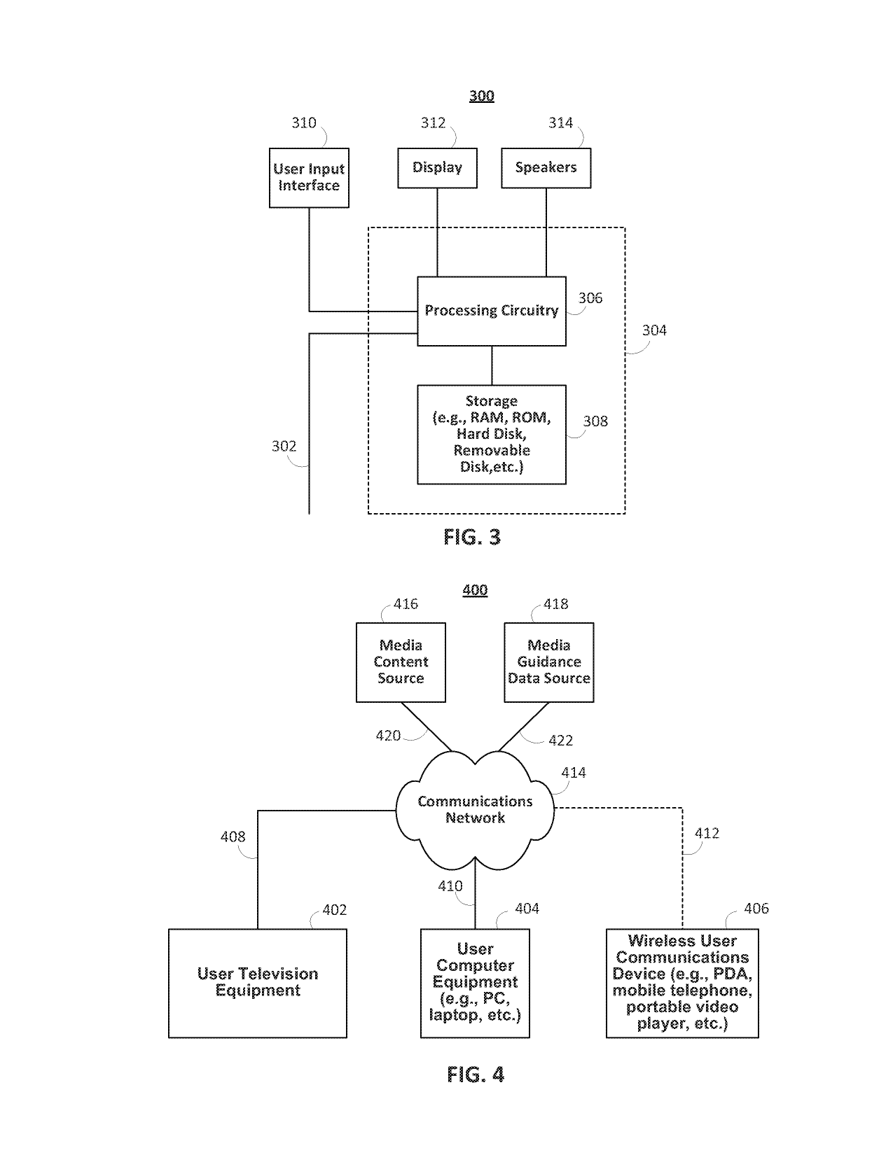

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308. Storage 308 may be used to store other user profiles database 930, user profile database 940, parental control database 950, and power-on state database 960, as discussed below in connection with FIG. 9.

License files including information about the identity of the user and/or user equipment device 300 and media content access right and permission information may be stored on storage 308. License files may be used by the media guidance application to determine content source 416s accessible by the user. The user or user equipment device 300 may be identified by a unique number. Media content authorization information may describe access rights to media content and permission information. Access rights may describe conditions of access to one or more media content. For example, authorization may be in terms of subscription to a grouping of media content that are provided by a media content service provider for a period of time, and may depend on the terms of a service agreement between a user and the copyright owner or distributor. For example, a user may be subscribed to access the entire television series of Battlestar Galactica or the user may be subscribed to a sports broadcast package that grants access to a number of pay-per-view shows or a number of sports channels.

License files may also include decryption keys for encrypted content. For example, encrypted music, video, or other content may be stored in storage 308 and a corresponding license file may be required to unlock the content and peruse it. It may not be possible to unlock the content without having possession of the corresponding license file. License files may also store a user's website-credentials. For example, the user's authentication information for a website like Hulu or Netflix may be encrypted and stored in storage 308. Control circuitry 304 may need to access the corresponding license file in order to decrypt the website-credentials stored in storage 308. Accordingly, in order to peruse the content or access the relevant website, on a device other than user equipment device 300, it may be necessary in to transfer the license file in tandem with the desired content and website-credentials. In some implementations, the license file may be stored on a server under the ownership of the copyright owner or distributor. In such instances, control circuitry 304 may retrieve the license file from the server when required.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. In some embodiments, user input interface 310 may store, transmit, and/or receive information associated with and/or identifying a particular user device. This information may be used by control circuitry 304 to detect and/or identify that the particular user device is within a predetermined detection region of the user's device. The user device may then be added to a list of active user devices at the user's device and/or logged into the user's device.

Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

In some embodiments, control circuitry 304 may use any suitable method to determine the distance, trajectory, and/or location of another user in relation to user equipment device 300. For example, control circuitry 304 may use received signal strength indication (RSSI) reflected from a user to determine the distance the user is from user equipment device 300. For example, RSSI values may be triangulated to determine the location of the user. Control circuitry 304 may also use, for example, triangulation and/or time difference of arrival determination of appropriate information to determine the location of the user. For example, time difference of arrival values of sounds emanating from another user device may be determined. In some embodiments, an echo-location type system may be used to detect other user devices. In some embodiments, any suitable image processing, video processing, and/or computer vision technique may be used to identify a user. A user's distance, trajectory, and/or location in relation to user equipment device 300 may be determined using any suitable method. For example, control circuitry 304 may detect and identify users by using these techniques.

The measurable distance may be limited by ability of the detecting circuitry to resolve or measure features. For example, the measurable distance from which a camera may resolve two spaced points may be limited based on optical resolution of the camera. For example, the measurable distance from which a wireless antenna may be able to detect a received signal above background noise may depend on the initial intensity of the transmitted signal and an absorption coefficient of the surround transmission medium.

Control circuitry 304, by using wireless techniques, may also be capable of detecting and/or identifying a user or users based on recognition and/or identification of a media device (e.g., a mobile device, such as an RFID device or mobile phone) that may be associated with the user or users. Control circuitry 304 may recognize and identify such a device using any suitable means, for example, radio-frequency identification, Bluetooth, Wi-Fi, WiMax, internet protocol, infrared signals, any other suitable IEEE, industrial, or proprietary communication standards, or any other suitable electronic, optical, or auditory communication means. For example, control circuitry 304 may determine that a user is within a predetermined detection region of a media device, identify the user, and add the user to a list of active users at the media device. The detection and identification of users as described herein may not require any affirmative action on the part of the user beyond, in some embodiments, the configuration of such methods and systems. For example, any detection and identification of users may be done automatically by media devices.

In some embodiments, control circuitry 304 may determine a location based on global positioning system (GPS) measurements, or in the case of cellular telephones, measurements based on cell-tower signals. Control circuitry 304 may use these measurements to determine location coordinates which may be transmitted to other user devices or servers. Control circuitry 304 may include circuitry capable of determining the presence and/or the location of other users in its vicinity. Any user within a particular range of the user's device may be a neighboring user.

Control circuitry 304 may include processing circuitry capable of interpreting gestures or motion detected by sensors on-board user equipment device 300. Control circuitry 304 may include an accelerometer, a gyroscope, a magnetometer, or other similar circuitry capable of sensing and interpreting movements of user equipment device 300. Control circuitry 304 may also include a proximity sensor capable to detecting when other devices are in the vicinity of user equipment device 300.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

For illustrative purposes, the present invention is described in the context of a media guidance application implemented on user equipment device 300 that enables a user to configure a power-on state of user equipment device 300 and/or the media guidance application. In an illustrative embodiment, when user equipment device 300 receives a request to power off, the media guidance application may display multiple power-on state options from which the user may select a power-on state.

For example, when a user powers off user equipment device 300, the user may wish to set up user equipment device 300 to automatically power on at a later time when certain criteria related to media content are satisfied or to perform certain actions related to media content when user device 300 powers on. As an illustrative example, the user may configure user equipment device 300 to automatically tune to a preferred show the next time user equipment device 300 powers on. The user may alternatively configure user equipment device 300 to automatically power on when a preferred show is broadcast. Such features that configure future behavior of user equipment device 300 may advantageously make powering user equipment device 300 on or off more user friendly.

A power-on state may define the future behavior of user equipment device 300, i.e., the media content related actions performed by user equipment device 300 when it powers on. The user may customize a power-on state, choose a power-on state from a list of power-on state options, elect to use a default power-on state, and/or rely on power-on state options recommended by the media guidance application based on the user's profile.

In an implementation, the user may select a power-on state in response to instructing user equipment device 300 to power off. For example, the media guidance application may present multiple power-on state options to the user on a power-off screen. This may advantageously enable the user to configure the behavior of user equipment device 300 after it powers on before user equipment device 300 powers off.

In an implementation, the power-on state selected by the user may remain active for a predetermined number of times user equipment device 300 powers on or for a predetermined time duration. For example, if a selected power-on state specifies that, upon powering on, user equipment device 300 should display the latest event at the 2012 Olympics, the power-on state may remain in force only for the time duration that the 2012 Olympics are running.

In an implementation, the selected power-on state may be subject to parent control restrictions. For example, parental control restrictions limiting viewing of media content with excessive violence may be in place. Accordingly, based on the identity of the user, the selection of a power-on state specifying media content with graphic violence may be precluded. For example, if the user is a child, the parental control restrictions may be enforced. If the user is an adult, the parental control restrictions may not be enforced.

In an implementation, the user may be part of a social network and the user's social network friends may recommend power-on state options to the user. For example, the user's friend, Bob, may send a power-on state recommendation to the user specifying that the user equipment device 300 should power on during the live broadcast of the Superbowl.

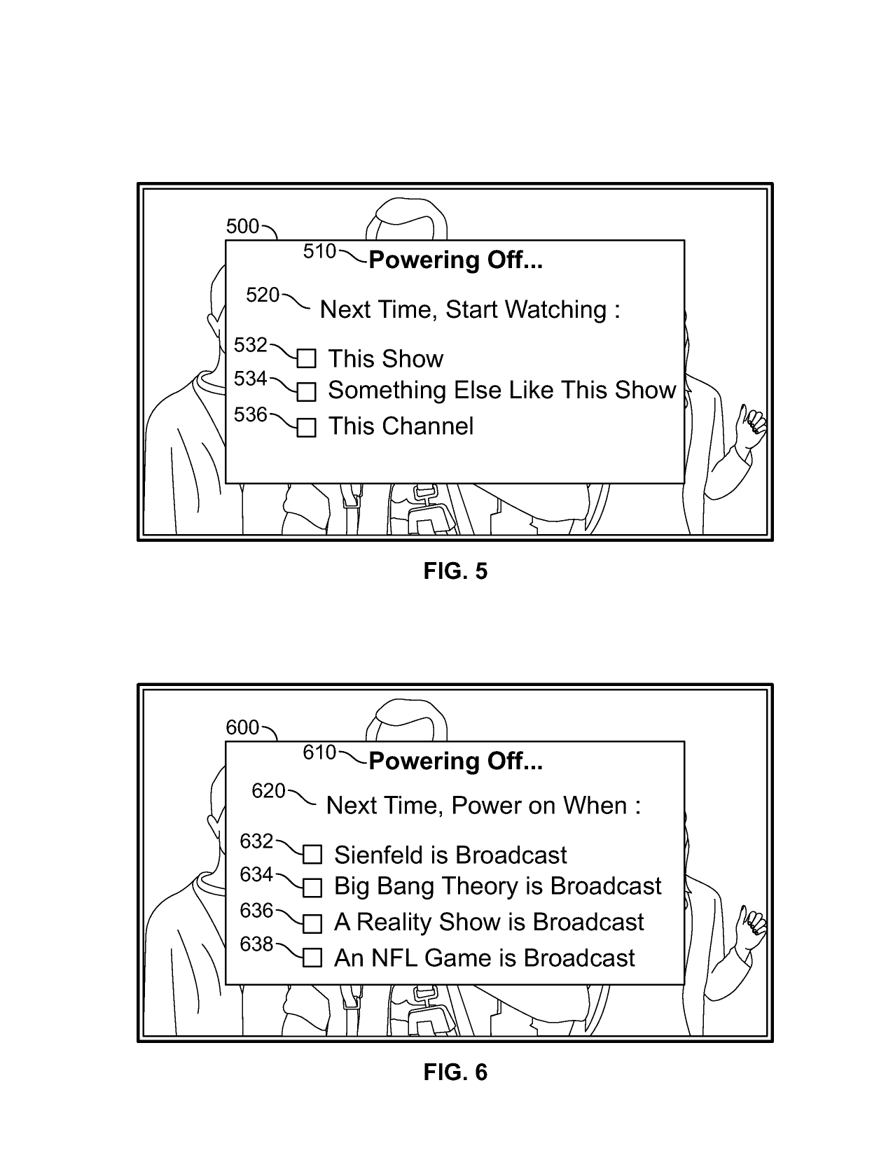

FIG. 5 shows an illustrative display screen showing a power-off screen with power-on state options, in accordance with an embodiment of the invention. FIG. 5 shows screen 500 which may be displayed in response to a request to power off being received by user equipment device 300. Screen 500 includes title 510, action 520, and power-on state options 532, 534, and 536.

A user may instruct user equipment device 300 to power off by toggling an appropriate power on/off button on a remote control (not shown) associated with user equipment device 300 or by toggling a hardware switch of user equipment device 300. In some implementations, user equipment device 300 may detect the absence of a user in the vicinity of user equipment device 300 and automatically choose to power off. Any other suitable technique for powering off user equipment device 300 may also be used.

In response to receiving a user request to power off or any other suitable instruction to power off, the media guidance application may display power off screen 500. Power-off screen 500 may provide a visual indication to the user that user equipment device 300 will power off shortly. Additionally power off screen 500 may enable the user to select a power-on state that may govern the actions performed by user equipment device 300 the next time user equipment device 300 powers on.

As discussed below in connection with FIG. 9, the power-on state of user equipment device 300 may be stored in a memory. In an implementation, the media guidance application may utilize the stored power-on state to perform certain actions the next time user equipment device 300 is powered on. User equipment device 300 may subsequently power off, and upon next being powered on, the media guidance application of user equipment device 300 may evaluate the power-on state stored in memory to decide an action to perform.

Title 510 may indicate to the user that user equipment device 300 has received a request to power off. Title 510 may include any suitable combination of text, graphics, or other visual indicators. Action 520 may indicate the action user equipment device 300 may perform the next time user equipment device 300 powers on. For example, the action to be performed by user equipment device 300 when it powers on next may be indicated by power-on state options 532, 534, and 536. Action 520 may be displayed using any suitable combination of text, graphics, or other visual indicators.

Power-on state options 532, 534, and 536 may provide multiple power-on states from which a user may select a power-on state. The selected power-on state may govern the behavior of user equipment device 300 when user equipment device 300 next powers on. For example, power-on state option 532 may specify that the next time user equipment device 300 powers on, the media guidance application should display media content that is currently being displayed, e.g., media content that is currently tuned, on user equipment device 300.

For example, the user may be watching an episode of Seinfeld and may decide to power off user equipment device 300 while the episode of Seinfeld is still ongoing or after the episode of Seinfeld has ended. In response to receiving the user's request to power off user equipment device 300, the media guidance application may display power-off screen 500 including multiple power-on states selectable by the user. If the user selects power-on state option 532, then the next time that user equipment device 300 powers on, the media guidance application may tune to an episode of Seinfeld. For example, the media guidance application may retrieve an indication of the show from storage 308.

In some implementations, when user equipment device 300 next powers on, Seinfeld may be viewable on a broadcast or an on-demand channel that the user has access to. The media guidance application may tune to the channel on which Seinfeld is viewable so that the user may view Seinfeld. In other cases, when user equipment device 300 next powers on, Seinfeld may be available only on content source 416 that the user is not permitted to access. The media guidance application may indicate to the user that Seinfeld is available for viewing on content source 416 that the user is not currently authorized to access. If the user is desirous of viewing Seinfeld, the user may obtain authorization to access content source 416 on which Seinfeld is available by making an appropriate payment. In some implementations, the media guidance application may periodically monitor media content listings to determine when Seinfeld may be available from content source 416 accessible by the user. The media guidance application may inform the user that Seinfeld is not currently available from content source 416 accessible by the user but it will continue to monitor the media content listings.

Power-on state option 534 may specify that the next time user equipment device 300 powers on, the media guidance application should display media content that is similar to the media content being viewed by the user before the request to power off user equipment device 300 was received. For example, the media guidance application may assess the similarity of media content based on media content attributes such as genre, parental guidance rating, actors in the media content, or geographical location depicted in the media content. Any other suitable attributes and/or combination of attributes may also be used.

If power-on state option 534 is selected by the user, the media guidance application may determine the attributes associated with the media content being viewed by the user before the request to power off user equipment device 300 was received. Media content attributes may accompany the media content as auxiliary analog or digital data. For example, if the media content is broadcast, attributes may be included in Vertical Blanking Information (VBI) data. If the media content is on-demand, the attributes may be included as data that is part of the media content. Media content attributes may additionally and/or alternatively be available to the media guidance application from media content source 416. In an implementation, the media guidance application may determine attributes of the media content by considering a channel on which the media content is broadcast, identifying actors or geographical locations in the media content by using image recognition, or any other suitable attribute identification techniques.

When the media guidance application has identified attributes associated with the media content being viewed by the user before the request to power off user equipment device 300 was received, the media guidance application may store the identified attributes in storage 308. When user equipment device 300 next powers on, the media guidance application may search available media content sources for media content with attributes that match the attributes previously stored in storage 308. For example, if the user was watching Seinfeld before user equipment device 300 was powered off, then when user equipment device 300 is next powered on the media guidance application may display The Big Bang Theory because both media assets belong to the comedy genre.

If power-on state option 536 is selected by the user, the media guidance application may store, in storage 308, an identifier associated with the channel or media content source currently being viewed by the user. Accordingly, when user device 300 powers on next, the media guidance application may retrieve the stored identifier from storage 308 and display media content currently available from the channel or media content source (e.g., Internet streaming site) associated with the retrieved identifier.

Power-on state options 532, 534, and 536 are shown in FIG. 5 by way of example and not limitation. Power-on state options may include any other suitable actions based on media content. For example, the power-on state may specify that, when user equipment device 300 powers on next, the media guidance application should display: media content unlike the media content the user was viewing when user equipment device 300 powered off or media content part of the same series of media content the user was viewing when user equipment device 300 powered off.

Power-on states may be based on content source 416 preferred by the user based on the day of the week and/or the time of the day. For example, the media guidance application may examine the user's profile to determine which channel the user typically watches on Sunday evenings. If the user powers off user equipment device 300 on Sunday afternoon and the user's profile indicates that the user frequently watches media content on Sunday evenings, the media guidance application may suggest a power-on state based on the channel or media content the user typically watches on Sunday evenings.

Based on the user's viewing habits, the media guidance application may determine that the user typically watches the same media content at a given time of a day, say 10:00 am. For example, the media guidance application may track media content viewed by the user. The media guidance application may additionally track the day and time that the user viewed media content. Accordingly, if user equipment 300 powers on at 10.00 am, then the media guidance application may display the media content typically viewed by the user at 10:00 am. In some implementations, the media guidance application may display default media content when user equipment device 300 powers on. The default media content may be based on the user's viewing habits, e.g., if the user watches The Weather Channel most frequently, the default media content displayed may be The Weather Channel.

Power-on states may be based on the user's media content viewing habits as determined by the media guidance application based on the user's profile. For example, if the user typically watches news content on weekday mornings, the media guidance application may suggest a power-on state accordingly. Specifically, the media guidance application may suggest a power-on state which specifies that user equipment device 300 power on during the next weekday morning and display news content.

Based on repetitive viewing habits of the user, which may be indicated by the user's profile, the media guidance application may elect to set a default power-on state. For example, if the user watches sports content almost exclusively, then the media guidance application may set the default power-on state such that sports media content is displayed any time user equipment device 300 powers on.

FIG. 6 shows an illustrative display screen showing a power-off screen with power-on state options, in accordance with an embodiment of the invention. FIG. 6 shows screen 600 which may be displayed in response to a request to power-off being received by user equipment device 300. Screen 600 includes title 610, action 620, and power-on state options 632, 634, 636, and 638. Screen 600, title 610, and action 620 may be substantially identical to screen 500, title 510, and action 520 discussed above in connection with FIG. 5.

Action 620 may indicate the next time user equipment device 300 should power on. For example, user equipment device 300 may power on when one of the conditions indicated by power-on state options 632, 634, 636, and 638 is satisfied, as described in greater detail below. Power-on state options 632, 634, 636, and 638 are shown in FIG. 6 by way of example and not limitation. Other suitable power-on state options may also be used.

If the user selects power-on state option 632, then user equipment device 300 may next power on whenever Seinfeld is available for viewing from content source 416 that is accessible to the user. Similarly, if the user selects power-on state option 634, then user equipment device 300 may next power on whenever Big Bang Theory is available for viewing from content source 416 that is accessible to the user.

If the user selects power-on states 632 or 634 specifying that user equipment device 300 should power on when a specific media content is available for viewing, the media guidance application may search media content listings for the next time when the media content specified by the selected power-on state is available for viewing. For example, if the user selects power-on state 632, the media guidance application may search media content listings for the next time that Seinfeld is available for viewing. The media guidance application may further notify the user of the next time that user equipment device 300 will power on based on the search result. In some embodiments, the media guidance application may continue to monitor the media content listings even after user equipment device 300 has been powered off.

The media guidance application may limit its search of the media content listings to media content sources that are accessible by the user. For example, if the user does not have subscriber access to HBO, the media guidance application may skip searching media content listings corresponding to HBO. If the media guidance application determines that Seinfeld will be available for viewing on multiple media content sources accessible by the user, the media guidance application may generate a screen for display (not shown) prompting the user to select the preferred viewing time. User equipment device 300 may accordingly be configured to power on at the preferred time.

The media content specified by power-on states 632 and/or 634 may be customized by the user. For example, the user may specify any preferred media content from content source 416 accessible by the user. Alternatively and/or additionally, the media guidance application may determine the media content specified by power-on states 632 and/or 634 based on the preferences of the user. For example, the media guidance application may refer to the user's profile to determine the user's favorite media content items and subsequently generate power-on state options 632 and/or 634 based on the user's favorite media content items.

Some power-on state options may allow the user to specify a genre or type of media content instead of specific media content. Such power-on states may be used to configure user equipment device 300 to power on when media content of the genre or type specified by the selected power-on state is available for viewing from a media source accessible to the user.

For example, if the user selects power-on state option 636, then user equipment device 300 may next power on whenever a reality show is available for viewing from content source 416 accessible to the user. The media guidance application may search media content listings for the next time when the media content of the reality show genre is available for viewing and configure user equipment device 300 to power on at the appropriate time and display the appropriate media source.

Similarly, if the user selects power-on state option 638, then user equipment device 300 may next power on whenever an NFL game is available for viewing from content source 416 accessible to the user. Power-on state options 636 and 638 are merely illustrative and any other suitable genre or type of media content may be specified by the power-on state options. For example, power-on states may allow the user to setup user equipment device 300 to next power on when media content of the genre drama, comedy, sports, music, educational, adult, etc., and/or media content of the type sports event, live music event, movie, game show, etc. are available for viewing from a media source accessible by the user.

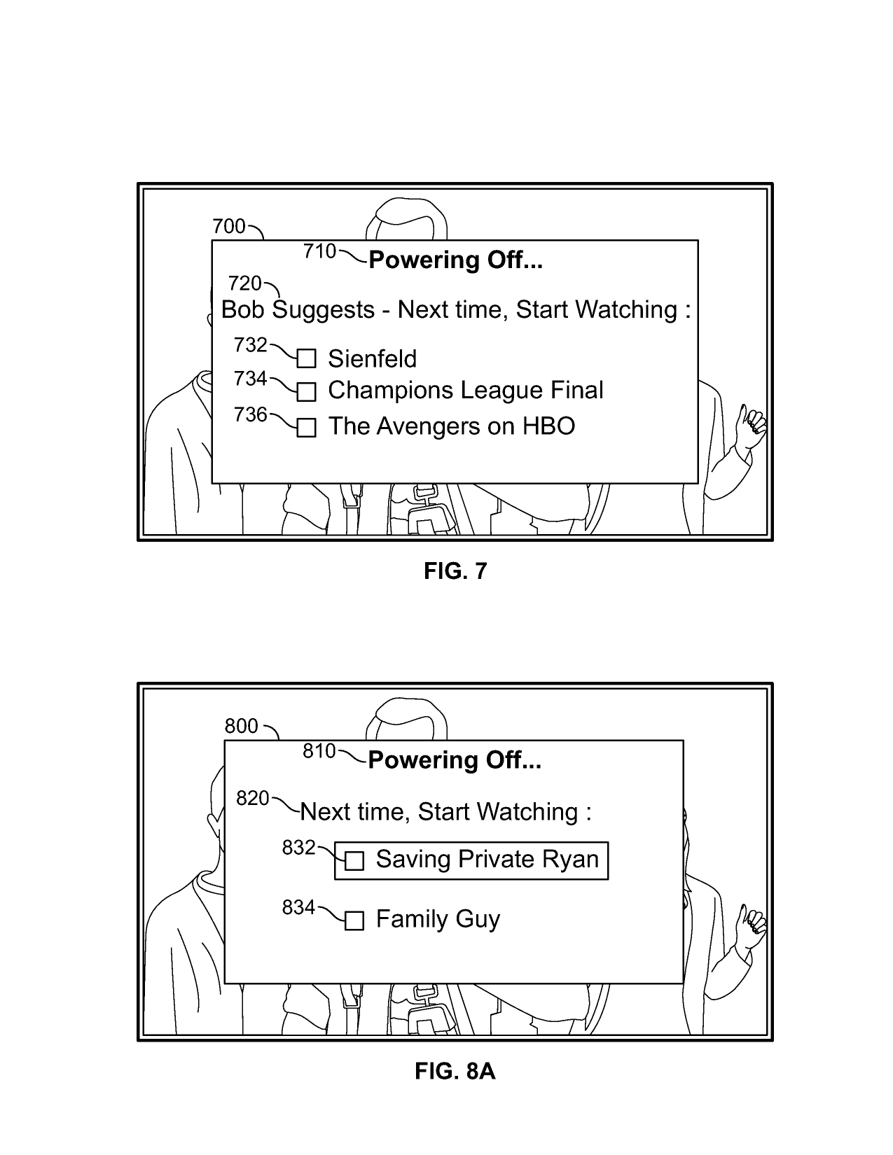

FIG. 7 shows an illustrative display screen showing a power-off screen with power-on state options based on the user's friends' recommendations, in accordance with an embodiment of the invention. FIG. 7 shows screen 700 which may be displayed in response to a request to power off being received by user equipment device 300. Screen 700 includes title 710, action 720, and power-on state options 732, 734, and 736. Screen 700, title 710, and action 720 may be substantially identical to screen 500, title 510, and action 520 as discussed above in connection with FIG. 5.

Action 720 may indicate the action user equipment device 300 may perform the next time user equipment device 300 powers on. For example, the action to be performed when user equipment device 300 powers on next may be indicated by power-on state options 732, 734, and 736. Action 720 may be displayed using any suitable combination of text, graphics, or other visual indicators.

Power-on state options 732, 734, and 736 may be power-on states suggested by the user's social network friends. Processing circuitry 306 may provide social network functionality with which users may create profiles and circles of friends, family, and acquaintances with whom to share preferred power-on states and any other relevant information. Processing circuitry 306 may evaluate the interests of the social network friends of the user and make power-on state recommendations based on the interests of the user's friends. The media guidance application may prompt the user to accept or decline the suggested power-on states that processing circuitry 306 gleans from the user's social network friends.

In some embodiments, existing social network services like Facebook, Google+, etc. may be used alternatively and/or additionally to the social network functionality provided by processing circuitry 306. Processing circuitry 306 may obtain information indicative of the interests of the user's social network friends from the social network service or any other electronic communication, such as email or instant messages, received from the user's friends. The media guidance application may make recommendations of power-on state options to the user based on such information.

For example, the user may befriend Bob on the social network. Based on his knowledge about the user, Bob may suggest power-on states. This may provide Bob an easy avenue for providing media content recommendations to the user. For example, if Bob wants to suggest that the user watch the next episode of Seinfeld, Bob may create a power-on state specifying that the next time Bob's user equipment device powers on, Seinfeld be displayed, and subsequently share the created power-on state with the user. Processing circuitry 306 may receive the suggested power-on state from Bob. The media guidance application may subsequently present the received power-on state as power-on state option 732 to the user the next time the user instructs user equipment device 300 to power off. In some implementations, the media guidance application may prompt the user to accept or decline the power-on state received from Bob before presenting the received power-on state as an option.

Similarly, power-on state options 734 and 736 may also be power-on state options received from Bob. Power-on state option 734 may specify that the next time user equipment device 300 powers on, the media guidance application should display the UEFA Champions League Final Soccer game. Power-on state option 736 may specify that the next time user equipment device 300 powers on, the media guidance application should display The Avengers movie on HBO.

In some implementations, the media guidance application may learn the preferred, shared, and/or default power-on states of the user's social network friends by using processing circuitry 306. The media guidance application may accordingly present power-on state options on screen 700 based on the power-on states of the user's social network friends.

Action 720 may indicate to the user that the power-on state options presented on screen 700 were suggested by Bob. Screen 700 may additionally and/or alternatively display power-on state options suggested by the user's other friends on the social network. Accordingly, action 720 may identify each of the user's friends from whom the power-on state options displayed on screen 700 were received.

In some implementations, action 720 may specify that the user equipment device 300 should power on when media content specified by the power-on state selected by the user is available for viewing on content source 416 accessible by the user. For example, if the user selects power-on state 734, action 720 may specify that user equipment device 300 should power on when the UEFA Champions League Soccer Final game is available for viewing.

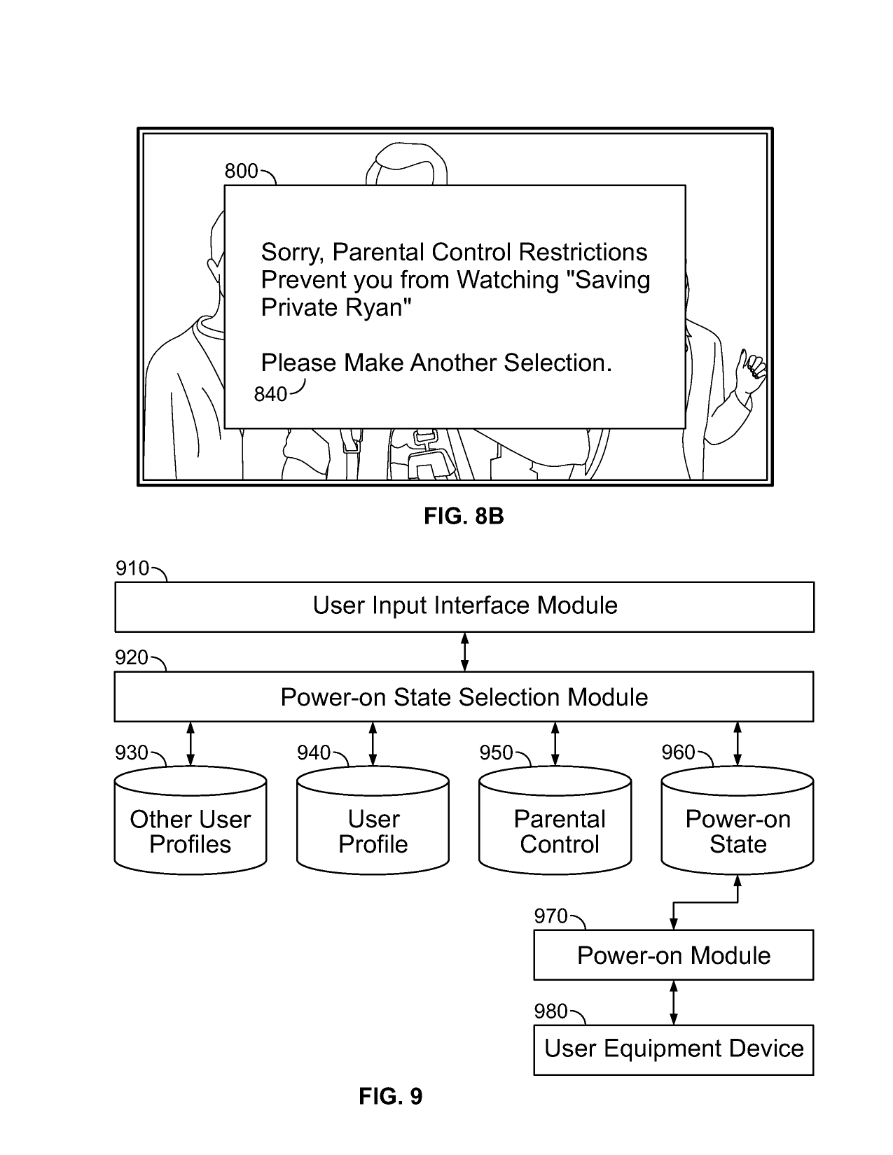

In some implementations, the media guidance application may restrict the selection of certain power-on states based on restrictions set up by parental controls. For example, if parents wish to prevent their children from accessing media content with excessive violence, parents may setup appropriate controls restricting access to media content with excessive violence. As described below in connection with FIGS. 8A and 8B, the media guidance application may accordingly prevent the user from selecting a power-on state specifying that when user equipment device 300 powers on, media content with excessive violence be displayed.

FIGS. 8A and 8B show an illustrative display screen showing a power-off screen with power-on state options restricted by parental controls, in accordance with an embodiment of the invention. FIG. 8A shows screen 800 which may be displayed in response to a request to power-off being received by user equipment device 300. Screen 800 includes title 810, action 820, and power-on state options 832 and 834. Screen 800, title 810, and action 820 may be substantially identical to screen 500, title 510, and action 520 as discussed above in connection with FIG. 5.

As an example, action 820 may specify that, when user equipment device 300 powers on, the media guidance application should display the media content specified by the selected power-on state. Action 820 may alternatively specify any other suitable action as well. Power-on state option 832 may accordingly specify that when user equipment device 300 powers on, the media guidance application should display the movie Saving Private Ryan. Power-on state option 834 may specify that, when user equipment device 300 powers on, the media guidance application should display Family Guy.

In an illustrative example, parental control settings may restrict viewing of media content with excessive violence, as discussed above. Accordingly, the media guidance application may prevent the user from selecting a power-on state option that specifies media content with excessive violence. In particular, if the user selects power-on state option 832 specifying Saving Private Ryan, which has an R rating for violence, the media guidance application may display error message 840 on screen 800, as shown in FIG. 8B. The media guidance application may additionally prevent the user from selected power-on state option 832.

Error message 840 may inform the user of the reason why the user is not permitted to selected power-on state option 832. In the above example, error message 840 may cite restrictions based on parental control as the reason for not permitting the user to select power-on state option 832. The media guidance application may additionally prompt the user to select another power-on state option that is compatible with the parental control restrictions, as shown in FIG. 8B. For example, the media guidance application may permit the user to select power-on option 834 because Family Guy may not contain excessive violence. In some embodiments, the media guidance application may accept a password from the user and thus permit the user to access restricted power-on state options.

Parental controls may specify any other suitable restrictions on media content viewable on user equipment device 300. For example, parental controls may restrict access to media content with adult themes, violence, or foul language. Parental controls may alternatively and/or additionally restrict access to media content based on a genre of media content, day of week or time of day, price of on-demand content, or any other suitable criterion. Parental controls are described in greater detail in Leung et al. U.S. Pat. No. 8,006,260, issued Aug. 23, 2011, which is hereby incorporated by reference herein in its entirety.

Processing circuitry 306 may be operable to detect the identity of the user via facial recognition made possible through an image sensor. During a configuration phase of user equipment device 300, the media guidance application may learn to identify all members of a household in which user equipment device 300 is located. Identified members of the household may be classified as household members with restricted privileges or non-restricted privileges. For example, children may have restricted privileges while adults may have non-restricted privileges.

In some implementations, the media guidance application may elect to restrict user selection of a power-on state in view of parental control restrictions based on the identity of the user. For example, if a child is operating user equipment device 300, the media guidance application may detect that the current user is a child with restricted privileges. Accordingly, the media guidance application may restrict the child's selection of a power-on state in view of parental control restrictions.

FIG. 9 is a diagram of an illustrative system architecture for powering on the user equipment device according to a selected power-on state, in accordance with another embodiment of the invention. System architecture 900 includes user input interface 910, power-on state selection module 920, power on module 970, user equipment device 980, other user profiles database 930, user profile database 940, parental control database 950, and power-on state database 960. User input interface module 910 may be substantially similar to user input interface 310. User equipment device 980 may be substantially similar to user equipment device 300.

Power-on state selection module 920 may be coupled via communication lines to user input interface module 910, other user profiles database 930, user profile database 940, parental control database 950, and power-on state database 960. Databases 930, 940, 950, and 960 may be stored in storage 308 or any other memory internal or external to user equipment device 980. Databases 930, 940, 950, and 960 may be stored using any suitable database technology. For example, databases 930, 940, 950, and 960 may be SQL or any other suitable relational or other databases.

User profile database 940 may store user profile information. For example, the media guidance application may learn the viewing habits of the user over time and may store such information in user profile database 940. User profile information of all members of the household in which user equipment device 980 is located may also be stored in user profile database 940. Information pertaining to the user's social network friends may be stored in other user profiles database 930. For example, suggested power-on states received from the user's social network friends may be stored in other user profiles database 930.

Parental control database 950 may store information related to parental control restrictions. For example, parental control restrictions specifying that children may not view media content containing foul language may be stored in an appropriate format in parental control database 950. For example, a parental control restriction may be stored together with identifiers denoting the type of media content that is to be restricted, who is restricted from viewing the restricted media content, or the time duration the restrictions should be implemented for. Any other suitable identifiers may also be stored for each parental control restriction.

Power-on state database 960 may store some or all of the power-on states available for selection on user equipment device 980. Each power-on state may be stored with one or more identifiers representing the status of each power-on state. For example, identifiers may be used to denote whether a power-on state is a default power-on state, whether it has been selected by the user, whether it is restricted by parental controls, or whether it was recommended by one of the user's social network friends. Other identifiers may count the number of times or frequency with which a power-on state is selected.

Power-on state selection module 920 may be a part of processing circuitry 306. The media guidance application may also communicate with power-on state selection module 920. Power-on state selection module 920 may be responsible for facilitating the selection of a power-on state. Based on information stored in other user profiles database 930, user profile database 940, parental control database 950, and power-on state database 960, power-on state selection module 920 may present power-on state options on power-off screens 500, 600, 700, or 800 as described above in connection with FIGS. 5-8B in response to a user request to power off user equipment device 980.

For example, power-on state selection module 920 may retrieve information from user profile database 940 to recommend power-on states based on the user's preferences. If the user is fond of watching media content with a focus on current affairs, power-on state selection module 920 may present a power-on state which specifies that, when user equipment device 980 powers on, the media guidance application should display media content related to current affairs.

For example, power-on state selection module 920 may retrieve information from other user profiles database 930 to recommend power-on states based on the preferences or recommendations of the user's social network friends. If the user's friend, Bob, recommends that user equipment device 980 power on when the next episode of The Simpsons is available for viewing from content source 416 accessible by the user, power-on state selection module 920 may present such a power-on state to the user.

Once power-on state selection module 920 presents power-on states, the user may select one of the presented power-on states via user input interface module 910. User input interface module 910 may subsequently communicate information regarding the user's selection of a power-on state to power-on state selection module 920. In response to receiving information regarding the user's selection of a power-on state, power-on state selection module 920 may retrieve information from parental control database 950 to determine whether the power-on state selected by the user is restricted.

If power-on state selection module 920 determines that the power-on state selected by the user is restricted, then power-on state selection module 920 may prompt the user to select another power-on state. If power-on state selection module 920 determines that the power-on state selected by the user is not restricted, then power-on state selection module 920 may store the selected power-on state and/or information corresponding to the selected power-on state in power-on state database 960.

Power on module 970 may be coupled via communication lines to power-on state database 960 and user equipment device 980. Power on module 970 may configure user equipment device 980 and the media guidance application to perform the action specified by the power-on state selected by the user or the default power-on state. For example, power on module 970 may read power-on state database 960 to determine whether or not a power-on state has been selected by the user. Power on module 970 may search the identifiers corresponding to power-on state entries in power-on state database 960 to determine whether the user has selected a power-on state.

If power on module 970 makes a determination that the user has indeed selected a power-on state, then power on module 970 may extract information corresponding to the media content specified by the selected power-on state from power-on state database 960. If power on module 970 makes a determination that the user has not selected a power-on state, then power on module 970 may extract information corresponding to the media content specified by the default power-on state from power-on state database 960.

For example, if the default power-on state specifies that the media guidance application should display a reality show when user equipment device 980 powers on next, power on module 970 may make note of the media content identifier—e.g., reality show—and communicate this identifier to the media guidance application. Other suitable media content identifiers may also be used. When user equipment device 980 next powers on, the media guidance application may retrieve the reality show media guidance identifier and search media content listings for media content associated with the reality show media content identifier. If the search returns a positive result, the media guidance application may display the reality show indicated by the positive search result. If the search does not return a positive result, the media guidance application may notify the user that no reality show is currently available for viewing from content source 416 accessible by the user and present other relevant media content instead.

For example, if the default power-on state specifies that user equipment device 980 should next power on when an NFL game is available for viewing from content source 416 accessible by the user, power on module 970 may note the media content identifier—NFL game. Power on module 970 may request the media guidance application to determine the next time slot in which an NFL game will be available for viewing from content source 416 accessible by the user. Accordingly, the media guidance application may search media content listings for media content associated with the NFL game media content identifier.

If the media guidance application is successful in determining a time slot when an NFL game will be available for viewing from content source 416 accessible by the user, the media guidance application may store the time slot and content source 416 in storage 308. Power on module 970 may ensure that user equipment device 980 powers on at the determined time slot. Once user equipment device 980 powers on, the media guidance application may display the NFL game from the determined media content source.

If the media guidance application is unsuccessful in determining a time slot when an NFL game will be available for viewing from content source 416 accessible by the user, the media guidance application may communicate this to power-on state selection module 920. The media guidance application may notify the user that no NFL game is available for viewing from content source 416 accessible by the user and may suggest power-on states based on other relevant media content instead.

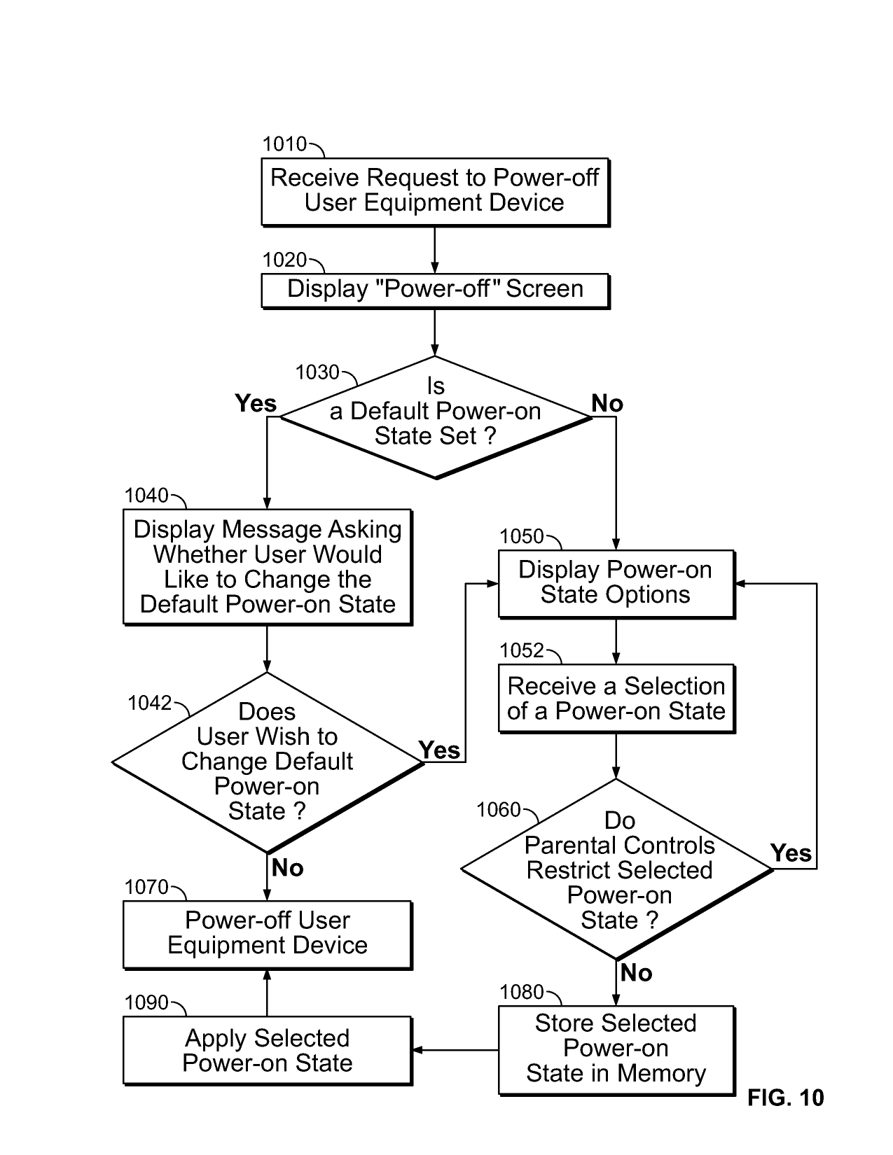

FIG. 10 shows an illustrative flow diagram for selecting a power-on state, in accordance with an embodiment of the invention. At step 1010, user equipment device 300 may receive a request from the user to power off. The user may make the request from a physical or virtual remote control associated with user equipment device 300, from hardware located on user equipment device 300, or any other suitable mechanism.

At step 1020, the media guidance application may display a power-off screen in response a request to power-off being received by user equipment device 300. The power-off screen may be displayed in the manner described above in connection with FIGS. 5-8B. For example, the media guidance application may receive a communication from processing circuitry 306 indicating that the user has requested user equipment device 300 to power off. In response, the media guidance application may display the power-off screen.

At step 1030, the media guidance application may make a determination as to whether a default power-on state has been set up. For example, the user may have selected a default power-on state specifying that user equipment device 300 should power on at 10 am every week day and display the news. In response to the determination that a default power-on state has not been set up, the process may proceed to step 1050. Otherwise the process may proceed to step 1040.

At step 1040, the media guidance application may request user input to determine whether the user would like to change the default power-on state. For example, the media guidance application may display the current default power-on state to the user for informational purposes. The media guidance application may further display a message to determine whether or not the user wishes to change the default power-on state.

At step 1042, the media guidance application may make a determination as to whether the user wishes to change the default power-on state. For example, the user may respond to the message displayed at step 1040 via user input interface 310. In response to the determination that the user wishes to change the default power-on state, the process may proceed to step 1050. Otherwise the process may proceed to step 1070 where user equipment device 300 may power off.

At step 1050, the media guidance application may present power-on state options to the user on the power-off screen. In some implementations, the power-on state options may be presented by the media guidance application in communication with power-on state selection module 920. The user may be prompted to select one power-on state from the presented power-on state options.

At step 1052, the media guidance application may receive a selection of a power-on state option from the user. For example, the user may position a highlight box around one of the power-on state options presented on the power-off screen and press a selection key or select a power-on state option using a touch gesture. The media guidance application may receive the user input via user input interface 310.

At step 1060, the media guidance application may make a determination as to whether the power-on state option selected by the user is restricted by parental controls. For example, the media guidance application, in communication with power-on state selection module 920, may retrieve information from parental control database 950 to determine whether the selected power-on state is restricted by parental control restrictions. This determination may be made in a manner similar to the manner described above in connection with FIG. 9. In response to the determination that the selected power-on state is restricted by parental control restrictions, the process may proceed back to step 1050. Otherwise the process may proceed to step 1080.

At step 1080, the selected power-on state option may be stored in power-on state database 960. The storage of the selected power-on state may be performed by the media guidance application in communication with power-on state selection module 920.

At step 1090, the selected power-on state may be applied to user equipment device 300. The application of the selected power-on state may be performed in the manner described above in connection with FIG. 9. For example, power on module 970 may configure user equipment device 300 to power on at a time specified by the selected power-on state. The media guidance application may display the media content specified by the selected power-on state once user equipment device 300 powers on. Once the selected power-on state has been applied, the process may proceed to step 1070 where user equipment device 300 may power off.

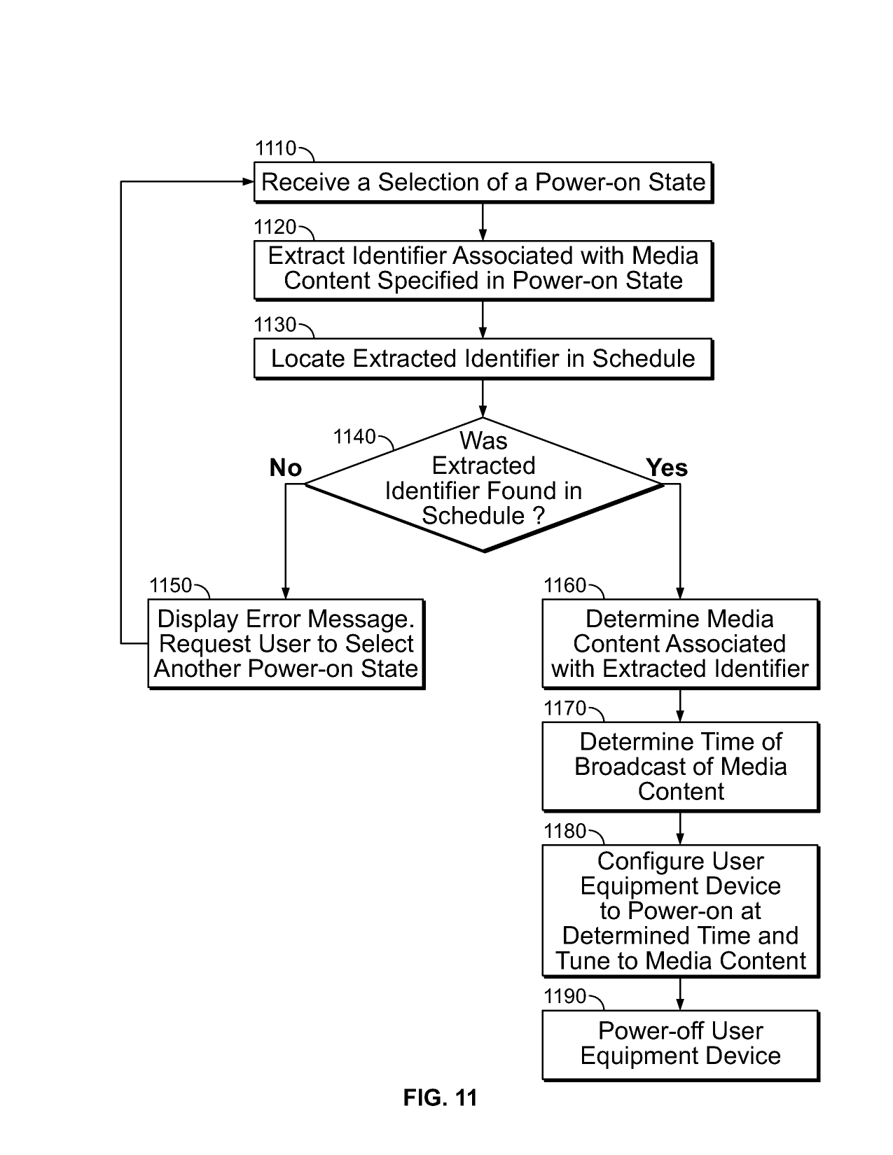

FIG. 11 shows an illustrative flow diagram for applying a selected power-on state, in accordance with an embodiment of the invention. For example, the power-on state option selected by the user may specify that user equipment device 300 should turn on when a reality show is available for viewing from content source 416 accessible by the user. The flow diagram shown in FIG. 11 illustrates the application of the selected power-on state in this case.

At step 1110, power-on selection module 920 may receive a selection of a power-on state option. The selection of the power-on state option may proceed in the manner similar to that described above in connection with FIG. 9. For example, power-on state selection module 920 may receive a user selection of a power-on state option from user input interface 310. Power-on state selection module 920 may further store the selected power-on state in power-on state database 960.

At step 1120, one or more media content identifiers associated with the media content specified in the power-on state stored at step 1110 may be extracted. Extraction of the media content identifiers may occur as described above in connection with FIG. 9. For example, power on module 970, in communication with the media guidance application, may read the media content identifiers associated with the power-on state stored at step 1110 from power-on state database 960.

At step 1130, the media guidance application may search media content listings for the media content identifiers extracted at step 1120. For example, if the media content identifier—e.g., reality show—was extracted from a stored power-on state which specified that user equipment device 300 should power on next whenever a reality show is available for viewing, the media guidance application may search media content listings for all available times and media content sources from which media content associated with a reality show media content identifier may be available.

At step 1140, a determination may be made as to whether the extracted one or more media content identifiers were located in the media content listings. For example, the media guidance application may determine that no media content in the media content listings matches the extracted media content identifiers. In response to the determination that no media content in the media content listings matches the extracted media content identifiers, the process may proceed to step 1150. Otherwise, the process may proceed to step 1160.

At step 1150, the media guidance application may display an error message indicating that no media content in the media content listings matches the extracted media content identifiers. The media guidance application may further prompt the user to select another power-on state option. The process may then proceed back to step 1110. For example, the media guidance application may determine that no media content in the media content listings, available at the time specified in the selected power-on state option, matches the extracted media content identifiers. Accordingly, the media guidance application may prompt the user to select another power-on state option specifying another time that user equipment device 300 should power on.

For example, the media guidance application may determine that no media content in the media content listings, available from content source 416 accessible by the user, matches the extracted media content identifiers. The media guidance application may further determine that media content in the media content listings, available from content source 416 not accessible by the user, matches the extracted media content identifiers. For example, content source 416 not accessible by the user may be a paid on-demand media content source. The media guidance application may accordingly notify the user and prompt the user to confirm whether or not the user would like to purchase access to the on-demand media content source.

At step 1160, the media guidance application may determine the media content associated with the media content identifiers found in the media content listings. For example, the media guidance application retrieve the title of the one or more media content associated with the media content identifiers found in the media content listings. If more than one media content associated with the media content identifiers is found, the media guidance application may select the most appropriate media content. For example, the media guidance application may select the media content that may become available at the earliest time slot. For example, the user may select the desired media content from a prompt.

At step 1170, the media guidance application may determine the time the media content identified at step 1160 may become available for viewing. For example, the media guidance application, in communication with power on module 970, may read the time slot during which the media content identified at step 1160 may become available for viewing from the media content listings. The media guidance application may display the time slot to the user and request the user to cancel or confirm the time slot.

At step 1180, power on module 970 may configure user equipment device 300 to power on at the time determined at step 1170. The media guidance application may display the media content identified at step 1160 when user equipment device 300 powers on. For example, power module 970 may initialize an internal counter that counts down to the time determined at step 1170. When the counter reaches zero, user equipment device 300 may power on. At step 1190, user equipment device 300 may power off.

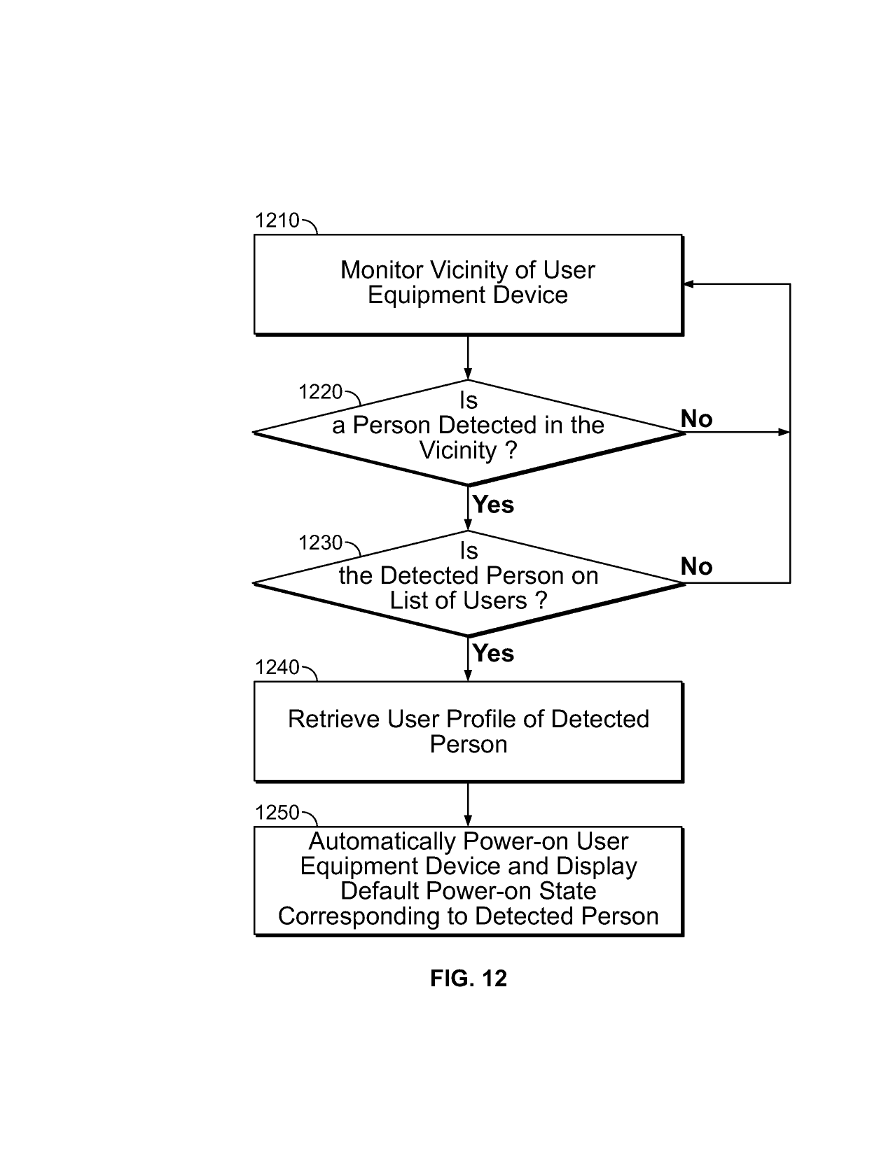

FIG. 12 shows an illustrative flow diagram for selecting a power-on state based on the identity of the user in the vicinity of the user equipment device, in accordance with an embodiment of the invention. At step 1210, user equipment device 300 may be in powered off state where it actively monitors it vicinity for the presence of a user. For example, user equipment device 300 may rely on motion sensors coupled to processing circuitry 306 to detect the presence of users in the vicinity of user equipment device 300.

At step 1220, a determination may be made as to whether a user is detected in the vicinity of user equipment device 300. For example, motion sensed by the motion sensors may be indicative of the presence of a user in the vicinity of user equipment device 300. Processing circuitry 306 may process the input received from the motion sensors to verify that any detected motion indeed corresponds to user activity. For example, processing circuitry 306 may disregard motion attributed to movement by household pets. In response to the determination that no user is detected in the vicinity of user equipment device 300, the process may proceed back to step 1210. Otherwise, the process may proceed to step 1230.

At step 1230, a determination may be made as to whether the detected user is a member of the household. For example, processing circuitry 306 may compare the determined identification characteristics of the user detected in the vicinity of user equipment device 300 to characteristics of users that are members of the household stored in storage 308. Characteristics of user that may be compared may include facial or anatomical characteristics. In response to the determination that the detected user is not a member of the household, the process may proceed back to step 1210. Otherwise, the process may proceed to step 1240.

At step 1240, the user profile of the detected user may be retrieved from user profile database 940. For example, the media guidance application may determine whether a default power-on state corresponding to the detected user is stored in user profile database 940. If a default power-on state corresponding to the detected user is found, the media guidance application may retrieve the default power-on state.

At step 1250, user equipment device 300 may power on and the media guidance application may display the media content specified by the default power-on state retrieved at step 1240. For example, the default power-on state retrieved at step 1240 may specify that user equipment device 300 should display The Simpsons when user equipment device 300 next powers on. Accordingly, the media guidance application may display The Simpsons when user equipment 300 powers on in response to the detection of the user in its vicinity.

In some implementations, the default power-on state retrieved at step 1240 may specify that user equipment device 300 should power on when a media content specified by the default power-on state is available for viewing from content source 416 accessible by the user. In this case, if user equipment device 300 detects the user corresponding to the default power-on state retrieved at step 1240 in its vicinity but no reality show is available for viewing, user equipment device 300 may not power on. Alternatively, user equipment device 300 may power on when it detects the user in its vicinity and present the user with an option to view other media content related to a reality show.

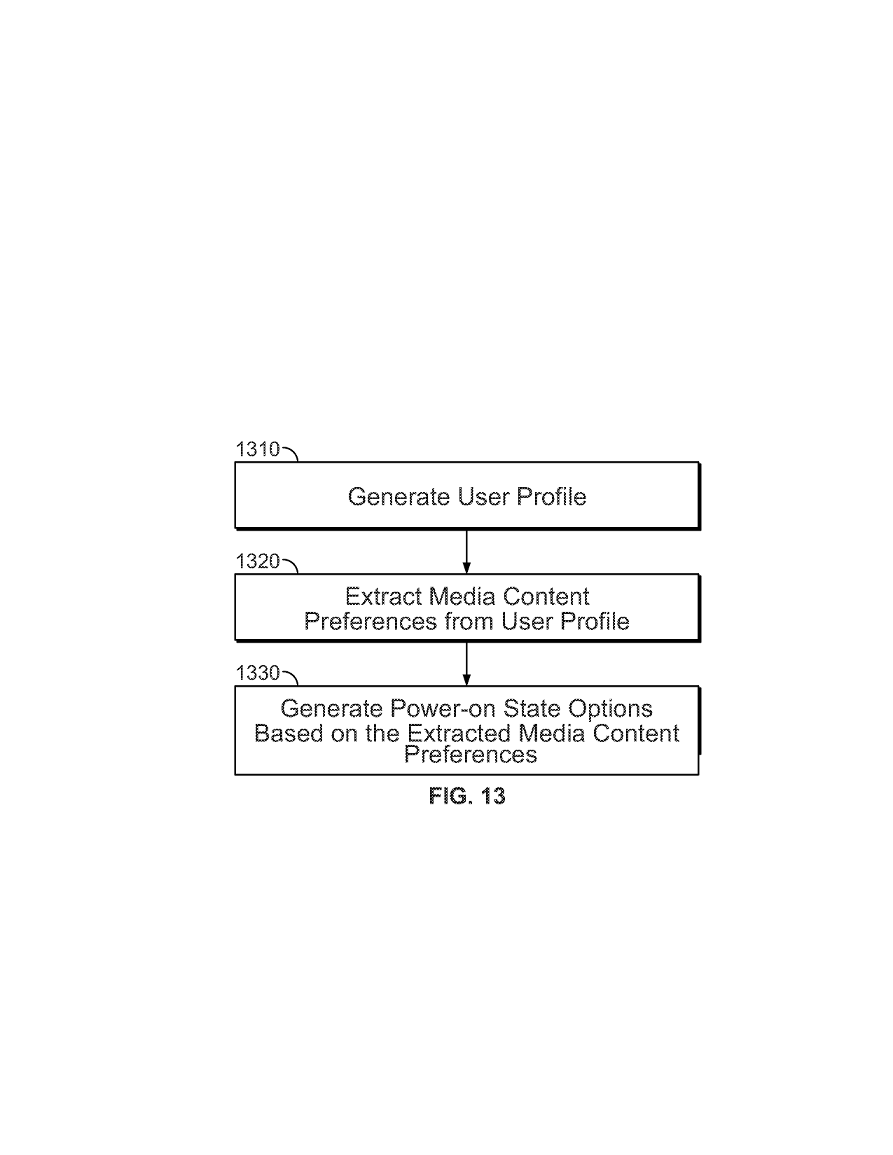

FIG. 13 shows an illustrative flow diagram for generating power-on state options, in accordance with an embodiment of the invention. At step 1310, a user profile may be generated. The user profile may be generated by the media guidance application. For example, the media guidance application may monitor the viewing habits of the user and determine the media content and media content sources most frequently watched by the user, the days of the week and the times of the days that the user most frequently consumes media content, and/or the media content preferred by the user at a particular time of the day or the week. The user may also provide user profile information to the media guidance application. Information relevant to the user profile may be stored in user profile database 940. User profiles may be generated for multiple members of the household in which user equipment device 300 is located.

At step 1320, the media guidance application may evaluate the user profile(s) stored in user profile database 940. The media guidance application may determine media content preferred by the user. The media guidance application may also determine the user's favorite media content for a particular time of the day or the time of the week. For example, the media guidance application may determine that the user enjoys watching an episode of Battlestar Galactica every week night. Based on the user profile, the media guidance application may further determine that the user does not watch any media content at any time other than week nights.

At step 1330, the media guidance application may generate one or more power-on state options based on the determination at step 1320. Continuing the above example, the media guidance application may generate a power-on state that specifies that user equipment device 300 should power on during weeknights and display Battlestar Galactica. The media guidance application may generate other suitable power-on states based on the user profile. The generated power-on states may be stored in power-on state database 960. The media guidance application may additionally generate power-on states for other members of the household based on their corresponding user profiles. The generated power-on state options may be displayed on the power-off screen as described above in connection with FIGS. 5-8B and 10-12. The user may subsequently select one of the displayed power-on state options. The selected power-on state option may be stored in a start-up routine as described above in connection with FIG. 12. User equipment device 300 may display the media content specified by the selected power-on state the next time user equipment 300 powers on.

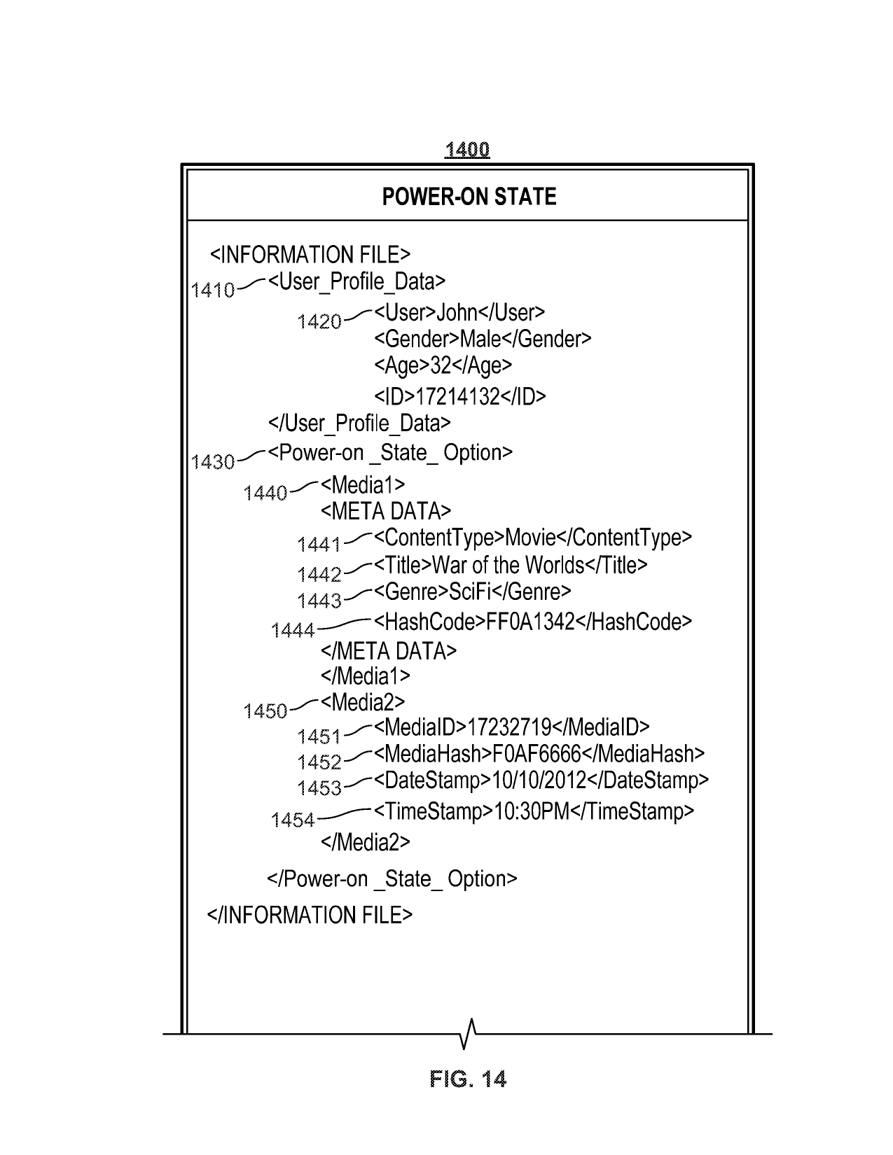

FIG. 14 illustrates an example of a format in which a power-on state may be stored, in accordance with an embodiment of the invention. Format 1400 may also be used when recommending power-on state options to social network friends. The format may carry information about the identity of the user and information corresponding to the power-on state being stored. The format may include user profile information section 1410 containing user profile data 1420. Depending on the power-on state, the format may include section 1430 that contains media content preferences such as media content 1440 and 1450.

User profile information section 1410 is used to identify the user. Section 1410 may include descriptive information 1420 about a user such as user ID number, name, gender, and age. The user ID number may be a unique number assigned to identify a user. Examples of such ID numbers may include national identity card numbers, social security numbers, passport numbers, or a hash code generated from the full name and birth date of the user.

Section 1430 may include information relevant to media content specified by the power-on state. For example, if a power-on state specifies that user equipment device 300 should power-on at 10:00 am on weekdays and display Battlestar Galactica, then such information may be included in section 1430 as described in greater detail below.

Listing 1440 is an example of information relevant to media content specified by the power-on state described by metadata, which may include information that describes a media content such as the content type, title, genre, composer, author, performer, file size, and time length of the media asset. Listing 1440 describes a media content having a content type 1441 of movie, title 1442 of “War of the Worlds,” and genre 1443 of sci-fi. For example, listing 1440 may specify that the next time user equipment device 300 powers on, the media guidance application should display media content specified by title 1442 and genre 1443. Hash codes 1444 may be used to securely protect metadata stored in plain text from tampering by unauthorized users.

In some implementations, control circuitry 304 may compute the hash code 1444 as the result of hashing a concatenation of the metadata 1441-1443, using a hashing algorithm only usable by control circuitry 304 of the user's mobile device. Modification of the plain text metadata in listing 1440 without modification of the hash code would corrupt the information in the listing 1440. If the hash codes do not match, control circuitry 304 determines that the user is not authorized to access the media content, and may invoke a penalty on the user, such as a fine, or revocation of all access rights in the content authorization information of the user.

Listing 1450 is an example of an indication of a user preference to display media content when user equipment device 300 powers on. Listing 1450 includes an ID number 1451, hash code 1452, date stamp 1453, and time stamp 1454. ID number 1451 may be a unique ID number for the media content. Date stamp 1453 and time stamp 1454 may indicate a date and time at which the access right expires. Hash code 1452 may be a hashed value of an ID number, date information, time information, user profile information, any other suitable content authorization information or subscription information or any combination thereof. The hash code may prevent against tampering of the access right. Format 1400 may also include any other suitable fields (not shown) for storing a power-on state.

It should be understood that the above steps of the flow diagrams of FIGS. 10-13 may be executed or performed in any order or sequence not limited to the order and sequence shown and described in the figures. Also, some of the above steps of the flow diagrams of FIGS. 10-13 may be executed or performed substantially simultaneously where appropriate or in parallel to reduce latency and processing times.

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

The above-described embodiments of the present disclosure are presented for purposes of illustration and not of limitation, and the present disclosure is limited only by the claims which follow.

1. A method for selecting a power-on state option using a media guidance application implemented on a user equipment device, the method comprising:
generating, for display, a power-off screen notifying a user that the user equipment device will power off, wherein the power-off screen includes a plurality of power-on state options designating media content to be displayed by the media guidance application when the user equipment device next powers on;
receiving a user selection of one of the plurality of power-on state options;
storing an indication of the selected power-on state option in a start-up routine in memory; and
powering off the user equipment device.

2. The method of claim 1 further comprising:
powering on the user equipment device;
executing the start-up routine stored in the memory, wherein the start-up routine comprises retrieving the selected power-on state option stored in the memory; and
displaying media content designated by the selected power-on state option.

3. The method of claim 1, wherein the start-up routine stores the media content designated by the selected power-on state option.

4. The method of claim 3, wherein the plurality of power-on state options displayed are subject to restrictions based on parental access control settings.

5. The method of claim 1 further comprising:
generating a user profile based on user preferences;
determining an indication of viewing habits of the user based on the user profile; and
determining the plurality of power-on state options designating media content based on a comparison of the determined indication and media content listings.

6. The method of claim 5 further comprising:
determining a default power-on state based on the user profile; and
storing the default power-on state in the memory.

7. The method of claim 6, wherein the user is a first user, the user profile is a first user profile, and the user equipment device is a first user equipment device, the method further comprising:
receiving, at the first user equipment device, a recommendation of a power-on state from a second user equipment device over a remote link, wherein:
second user profile is generated based on preferences of a second user,
the second user uses the second user equipment device, and
the first user equipment device and the second user equipment device communicate over the remote link;
storing the received power-on state in the memory; and
applying the stored power-on state to the first user equipment device.

8. The method of claim 6, wherein the plurality of power-on state options displayed on the power-off screen are adapted over time based on the user profile.

9. The method of claim 1, wherein the stored power-on state is effective for a predetermined number of times the user equipment device powers on.

10. The method of claim 1, wherein the user equipment device powers on based on a broadcast time of media content specified by the applied power-on state.

11. A system for selecting a power-on state using a media guidance application implemented on a user equipment device, the system comprising:
processing circuitry configured to:
generate, for display, a power-off screen notifying a user that the user equipment device will power off, wherein the power-off screen includes a plurality of power-on state options designating media content to be displayed by the media guidance application when the user equipment device next powers on; and
power off the user equipment device;
a user input interface module configured to receive a user selection of one of the plurality of power-on state options; and
a power-on state selection module configured to store an indication of the selected power-on state option in a start-up routine in memory.

12. The system of claim 11 further comprising a power on module configured to:
power on the user equipment device;
execute the start-up routine stored in the memory, wherein the start-up routine comprises retrieving the selected power-on state option stored in the memory; and
facilitate display of the media content specified by the selected power-on state option.

13. The system of claim 11, wherein the start-up routine stores the media content designated by the selected power-on state option.

14. The system of claim 13, wherein the plurality of power-on state options displayed are subject to restrictions based on parental access control settings.

15. The system of claim 11, wherein the processing circuitry is further configured to:
generate a user profile based on user preferences;
determine an indication of viewing habits of the user based on the user profile; and
determine the plurality of power-on state options designating media content based on a comparison of the determined indication and media content listings.

16. The system of claim 11, wherein the processing circuitry is further configured to:
determine a default power-on state based on the user profile; and
store a default power-on state in the memory based on the user profile.

17. The system of claim 16, wherein the user is a first user, the user profile is a first user profile, and the user equipment device is a first user equipment device, and wherein the processing circuitry is further configured to:
receive, at the first user equipment device, a recommendation of a power-on state from a second user equipment device over a remote link, wherein:
a second user profile is generated based on preferences of a second user,
the second user uses the second user equipment device, and
the first user equipment device and the second user equipment device communicate over the remote link;
store the received power-on state in the memory; and
apply the stored power-on state to the first user equipment device.

18. The system of claim 16, wherein the plurality of power-on state options displayed on the power-off screen are adapted over time based on the user profile.

19. The system of claim 11, wherein the stored power-on state is effective for a predetermined number of times the user equipment device powers on.

20. The system of claim 11, wherein the user equipment device powers on based on a broadcast time of media content specified by the applied power-on state.

21-30. (canceled)
